(19) United States
(12) Patent Application Publication
(10) Pub. No.: US 2024/0352218 A1
(43) Pub. Date: Oct. 24, 2024

(54) HIGH STRUCTURE CARBON BLACK AND PLASTIC COMPOSITIONS COMPRISING THE SAME

(71) Applicant: BIRLA CARBON U.S.A., INC., Marietta, GA (US)

(72) Inventors: Zhenpeng Li, Marietta, GA (US); Zhaokang Hu, Marietta, GA (US); Zachary A. Combs, Marietta, GA (US); Jun Tian, Marietta, GA (US); Zhen Lai, Marietta, GA (US)

(21) Appl. No.: 18/685,564

(22) PCT Filed: Aug. 23, 2022
(86) PCT No.: PCT/US2022/041217

§ 371 Date: Feb. 22, 2024

Related U.S. Application Data
(60) Provisional application No. 63/236,153, filed on Aug. 23, 2021.

(51) Int. Cl. C08K 3/04; C08J 3/20

(52) U.S. Cl. CPC C08K 3/04; C08J 3/201; C08J 2323/12; C08K 2201/001; C08K 2201/005; C08K 2201/006

(57) ABSTRACT

Polymer compositions comprising high structure filler materials and method for preparing such compositions while retaining structure.

### CROSS-REFERENCE TO RELATED APPLICATIONS

This application claims priority to U.S. Provisional Application No. 63/236,153, filed Aug. 23, 2021, the entirety of which is incorporated into this application by reference.

### BACKGROUND

### Technical Field

The present disclosure relates to carbon black materials, and specifically to high structure carbon black materials, together with methods of making and using such carbon black materials.

### Technical Background

Carbon black materials can be utilized in a variety of applications to impart desirable properties to polymeric materials. In various aspects, carbon black materials can impart electrical properties, such as, for example, increased conductance or increased resistivity to materials in which they are incorporated. Conductive carbon blacks can be used in a variety of application, including batteries.

The conductivity of a polymer comprising a carbon black filler can be related to the structure of the carbon black filler. While high structure carbon blacks can be produced, this high structure is usually reduced or broken-down when the filler is compounded into the polymeric system. Thus, there is a need for improved high structure filler containing polymeric materials and methods for produced the same. These needs and other needs are satisfied by the compositions and methods of the present disclosure.

### SUMMARY

In accordance with the purpose(s) of the invention, as embodied and broadly described herein, this disclosure, in one aspect, relates to carbon black materials, and specifically to high structure carbon black materials.

In one aspect, the disclosed polymer composition comprises a carbon black filler and a melt-processable polymer; wherein a tape sample prepared by extrusion of the polymer composition at an extrusion temperature (° C.) and at a screw speed (RPM), using a single- or twin-screw extruder having a screw diameter of about 16 mm and a length to diameter ratio of about 25:1, exhibits a percolation threshold of at least 5 weight percent less than a reference tape sample extruded from a substantially identical reference composition in the same single- or twin-screw extruder at the same feed rate (g/min) but (i) at a reference extrusion temperature (° C.) that is at least 5% lower than the extrusion temperature at which the tape sample is extruded and (ii) at a reference screw speed (RPM) that is at least 50% higher than the screw speed at which the tape sample is extruded; wherein the percolation threshold is the weight percent of carbon black filler in the melt-processable polymer at which the tape sample and reference tape sample exhibit a surface resistivity below about 106 ohm/square.

In another aspect, disclosed is a process for preparing a polymer composition, the process comprising: obtaining a polymer melt from a melt-processable polymer in a mixing device; mixing a carbon black filler into the polymer melt with the mixing device at a temperature (° C.) and a shear rate (s⁻¹) to provide the polymer composition; wherein a solid sample obtained from the polymer composition exhibits a percolation threshold of at least 5 weight percent less than a solid reference sample obtained from a substantially identical reference composition mixed in the mixing device (i) at a reference temperature (° C.) that is at least 5% lower than the temperature at which the polymer composition is mixed and (ii) at a reference shear rate (s⁻¹) that is at least 50% higher than the shear rate at which the polymer composition is mixed; wherein the percolation threshold is the weight percent of carbon black filler in the polymer composition at which the solid sample and solid reference sample exhibit a surface resistivity below about 10⁶ ohm/square.

In a further aspect, disclosed is a polymer composition comprising: a melt processable polymer; and a carbon black filler in an amount ranging from about 5% to about 30% by weight of the polymer composition; wherein a solid sample of the polymer composition exhibits a surface resistivity below about 106 ohm/square.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated in and constitute a part of this specification, illustrate several aspects and together with the description serve to explain the principles of the invention.

FIG. 1 is a plot of resistivity versus carbon black loading amount for exemplary polypropylene compounds comprising Birla Carbon Blacks BCD9114B, BCD9110P, and Birla Carbon's CONDUCTEX 7055 Ultra Carbon Black (referred to in this application as “C7055U”), showing a lower percolation concentration for BCD9114 with a polymer compound prepared under aggressive compounding conditions (low temperature, high screw speed, high shear).

FIG. 2 is a plot of resistivity versus carbon black loading amount for exemplary polypropylene compounds comprising Birla Carbon BCD9114B, BCD9110P, and C7055U carbon blacks, showing a 5% reduction in percolation concentration with a polymer compound prepared under gentle compounding conditions (high temperature, low screw speed, low shear), relative to the same compound prepared under aggressive compounding conditions.

FIG. 3 shows plots of aggregate size distribution for two exemplary carbon blacks, Birla Carbon BCD9110 and C7055U.

FIG. 4 shows a plot of void volume versus mean pressure for two exemplary carbon blacks, Birla Carbon BCD9110 and C7055U, showing the void volume of BCD9110 to be higher than C7055U.

FIG. 5 shows a plot of resistivity versus carbon black loading for two Birla Carbon/polypropylene compounds prepared under aggressive relative to gentle process conditions, showing an 8 wt % reduction in percolation threshold with the compound prepared according to gentle versus aggressive compounding conditions.

FIG. 6 shows a plot of V′/V for BCD9110 dry carbon black versus compounds in polypropylene prepared according to gentle and aggressive process conditions.

FIG. 7 is a plot showing wt. % of BCD9110 carbon black versus aggregate size retention with dry carbon black versus compounds prepared in polypropylene under gentle and aggressive processing conditions.

FIG. 8 shows a plot of resistivity versus carbon black loading for a PP/C7055U compound prepared by gentle and aggressive compounding processes, showing that the gentle process reduces the percolation concentration by about 10 wt. % relative to the same compound prepared under aggressive processing conditions.

FIG. 9 shows a plot of V′/V for C7055U dry carbon black versus compounds in polypropylene prepared according to gentle and aggressive process conditions.

FIG. 10 is a plot showing wt. % of C7055U carbon black versus aggregate size retention with dry carbon black versus compounds prepared in polypropylene under gentle and aggressive processing conditions.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

When the term “about” precedes a numerical value, the numerical value can vary plus or minus 10% unless stated otherwise.

The term “percolation threshold” refers to the lowest concentration of carbon black in a polymer compound capable of achieving conductivity. In one aspect, the percolation threshold is the weight percent of carbon black filler in a polymer compound at which the polymer compound exhibits a surface resistivity below about 10⁶ ohm/square. In another aspect, the percolation threshold is the weight percent of carbon black filler in a polymer compound at which the polymer compound exhibits a surface resistivity below about 10⁴ ohm/square.

The phrase “substantially identical reference composition” refers to a composition that is in all respects substantially identical in terms of components of the composition and amount of those components in weight percent (plus or minus 10 weight %, e.g., plus or minus 5 weight %, plus or minus 2 weight %, plus or minus 1 weight %,). In some aspects, the “substantially identical reference composition” refers to a composition that is in all respects identical in terms of components of the composition and amounts of those components within understood margins of measurement error. The reference composition, while substantially identical in terms of type and amount of melt-processable polymer, carbon black, and any other optional additives, will exhibit different physical properties (e.g., carbon black aggregate size, surface resistivity, among other properties) due to the differences in how the reference composition is mixed, relative to the inventive composition.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric.

As briefly described above, the present disclosure provides carbon black materials, and specifically high structure carbon black materials. In various aspects, such carbon black materials can impart desirable electrical properties in a certain applications, such as, for example, plastics.

Morphological characteristics of carbon black include, for example, particle size/fineness, surface area, aggregate size/structure, aggregate size distribution, and aggregate shape. Particle size is a measurement of diameter of the primary particles of carbon black. These roughly spherical particles of carbon black have an average diameter in the nanometers range. Particle size can be measured directly via electron microscopy or indirectly by surface area measurement. Average particle size is an important factor that can determine the dispersibility, tensile strength, tear resistance, hysteresis, and abrasion resistance in a rubber article while in liquids and plastics systems, the average particle size can strongly influence the relative color strength, UV stability, and conductivity of the composite. At equal structure, smaller particle size imparts higher tensile strength, tear resistance, hysteresis and abrasion resistance, stronger color, UV resistance, and increased difficulty of dispersion.

Carbon black particles coalesce to form larger clusters or aggregates, which are the primary dispersible units of carbon black. Aggregate size and structure are controlled in the reactor. Measurement of aggregate structure can be obtained from electron microscopy or oil absorption. Structure was historically measured by N-dibutyl phthalate, or DBP, absorption, now replaced by oil absorption number, or OAN (ASTM D2414-18, ISO 4656/1). Another measure of structure is the compressed oil absorption number, or COAN (ASTM D3493-18), where a carbon black sample is mechanically compressed prior to performing the oil absorption measurement. The difference between OAN and COAN values can be an indicator of the stability of the carbon black structure. Grades with relatively large aggregates with a high number of primary particles can be high structure grades, with bulkier aggregates that have more void space and high oil absorption. High structure carbon black can increase electrical conductivity.

The basic method for the production of carbon black is well known. Generally, carbon black is produced by the partial oxidation or thermal decomposition of hydrocarbon gases or liquids, where a hydrocarbon raw material (hereinafter called “feedstock hydrocarbon”) is injected into a flow of hot gas wherein the feedstock hydrocarbon is pyrolyzed and converted into a smoke before being quenched by a water spray. The hot gas is produced by burning fuel in a combustion section. The hot gas flows from the combustion section into a reaction section which is in open communication with the combustion section. The feedstock hydrocarbon is introduced into the hot gas as the hot gas flows through the reaction section, thereby forming a reaction mixture comprising particles of forming carbon black. The reaction mixture flows from the reactor into a cooling section which is in open communication with the reaction section. At some location in the cooling section, one or more quench sprays of, for example, water, are introduced into the flowing reaction mixture thereby lowering the temperature of the reaction mixture below the temperature necessary for carbon black production and halting the carbon formation reaction. The black particles are then separated from the flow of hot gas. A broad range of carbon black types can be made by controlled manipulation of the reactor conditions.

Many carbon black reactors normally comprise a cylindrical combustion section axially connected to one end of a cylindrical or frusto-conical reaction section. A reaction choke is often axially connected to the other end of the reaction section. The reaction choke has a diameter substantially less than the diameter of the reaction section and connects the reaction section to the cooling section. The cooling section is normally cylindrical and has a diameter which is substantially larger than the diameter of the reaction choke.

The carbon black material of the present invention can be made using techniques generally known in the carbon black art. Various methods of making the inventive carbon black are described below and in the Examples. Variations on these methods can be determined by one of skill in the art. In one aspect, the carbon blacks of the present invention can be produced in a carbon black reactor, such as those described generally in U.S. Pat. Nos. 4,927,607 and 5,256,388, the disclosure of which are hereby incorporated by reference in their entireties. Other carbon black reactors can be used, and one of skill in the art can determine an appropriate reactor for a particular application. Feedstock, combustion feeds, and quenching materials are well known in the carbon black art. The choice of these feeds is not critical to the carbon blacks of the present invention. One of skill in the art can determine appropriate feeds for a particular application. The amounts of feedstock, combustion feeds, and quenching materials can also be determined by one of skill in the art which are suitable for a particular application.

It is well known that carbon black exists as a collection of aciniform aggregates that cover a wide range of surface area and structure or absorptive capacity. The absorptive capacity or aggregate structure manifests itself through its impact on viscosity in a polymeric compound, with higher structure driving higher viscosity. More fundamentally and from a morphological standpoint, structure manifests itself through shape and/or the degree of aggregate complexity, with lower structure aggregates having a more compact, spherical and ellipsoidal structure and higher structure aggregates having a more branched and open architecture capable of occluding a significant amount of polymer. In certain aspects, the larger an aggregate size and/or the more branching that exists within an aggregate, the more electrically conductive a composite material will be that incorporates such carbon black.

Conventional high structure carbon blacks can be added to polymer composites for electrical conductivity, but the expected conductivity or percolation concentration cannot be achieved due to the carbon black structure breakdown during processing. In one aspect, the present disclosure provides carbon blacks and processing conditions to tune the conductivity and optimize the percolation concentration of polymer/carbon black composites.

Polymer composites incorporating conventional high structure carbon blacks usually provide inferior conductive performance. In one aspect, this can be attributed, in part, to the structure breakdown of high structure carbon blacks during compounding in polymers under high shear field. In one aspect, the present disclosure provides processing conditions to minimize the carbon black structure breakdown level for optimized conductive performance.

In one aspect, the methods described herein can provide a conductive composition comprising a highly structure carbon black.

In one aspect, the methods described herein can be applied to a variety of conductive carbon black materials. Conventional compounding methods comprise mixing one or more resins and one or more filler materials in equipment, such as a twin-screw extruder. When the filler material comprises a high structure filler, such as a high structure carbon black, the shear forces developed during compounding and/or extrusion or injection molding can result in the loss of filler structure. For example, high compounding shear forces can result in broken carbon black aggregates, and thus, lower filler structure and lower electrical conductivity values in the resulting polymeric article.

In one aspect, gentle and/or low shear processing conditions combining an inventive high structure carbon black with a polymer, such as for example, polypropylene. In such aspects, a percolation concentration can be achieved using about 5 wt. % less carbon black than in similar compositions and methods using aggressive, high shear mixing conditions. Such an improvement in electrical conductivity can be due to higher structure retention using the gentle, and/or low shear processing conditions.

Accordingly, in one aspect, the disclosed polymer composition comprises a carbon black filler and a melt-processable polymer; wherein a tape sample prepared by extrusion of the polymer composition at an extrusion temperature (° C.) and at a screw speed (RPM), using a single- or twin-screw extruder having a screw diameter of about 16 mm and a length to diameter ratio of about 25:1, exhibits a percolation threshold of at least 5 weight percent less than a reference tape sample extruded from a substantially identical reference composition in the same single- or twin-screw extruder at the same feed rate (g/min) but (i) at a reference extrusion temperature (° C.) that is at least 5% lower than the extrusion temperature at which the tape sample is extruded and (ii) at a reference screw speed (RPM) that is at least 50% higher than the screw speed at which the tape sample is extruded; wherein the percolation threshold is the weight percent of carbon black filler in the melt-processable polymer at which the tape sample and reference tape sample exhibit a surface resistivity below about 10⁶ ohm/square, e.g., below about 10⁴ ohm/square.

In a further aspect, the tape sample exhibits a percolation threshold of between 5 weight percent and 15 weight percent less, e.g., 5-10% or 5-8% less, than the reference tape sample. In one aspect, the reference extrusion temperature is between 5% and 15%, e.g., 5-10% or 5-8%, lower than the extrusion temperature at which the tape sample is extruded. In a further aspect, the reference screw speed is between 50% and 200%, e.g., 150%, higher than the screw speed at which the tape sample is extruded.

In one aspect, the tape sample and reference tape sample can be prepared using a twin-screw extruder such as a PRISM twin-screw extruder having a screw diameter of 16 mm and a length to diameter ratio of 25:1, at a feed rate of 30 g/min. In this aspect, the carbon black filler loading can range from 5-25% by weight of the polymer composition, e.g., 5-25% by weight a polypropylene polymer composition.

Similarly, in one aspect, the disclosed process for preparing a polymer composition comprises obtaining a polymer melt from a melt-processable polymer in a mixing device; mixing a carbon black filler into the polymer melt with the mixing device at a temperature (° C.) and a shear rate (s⁻¹) to provide the polymer composition; wherein a solid sample obtained from the polymer composition exhibits a percolation threshold of at least 5 weight percent less than a solid reference sample obtained from a substantially identical reference composition mixed in the mixing device (i) at a reference temperature (° C.) that is at least 5% lower than the temperature at which the polymer composition is mixed and (ii) at a reference shear rate (s⁻¹) that is at least 50% higher than the shear rate at which the polymer composition is mixed; wherein the percolation threshold is the weight percent of carbon black filler in the polymer composition at which the solid sample and solid reference sample exhibit a surface resistivity below about 10⁶ ohm/square, e.g., below about 10⁴ ohm/square.

In one aspect, the solid sample of the polymer composition prepared by the process exhibits a percolation threshold of between 5 weight percent and 15 weight percent less, e.g., 5-10% or 5-8% less, than the solid reference sample. In one aspect, the reference temperature is between 5% and 15%, e.g., 5-10% or 5-8%, lower than the temperature at which the solid sample is obtained. In a further aspect, the reference shear rate is between 50% and 200%, e.g., 150%, higher than the shear rate at which the solid sample is obtained.

In one aspect of the process, obtaining the polymer melt from the melt-processable polymer and mixing the carbon black filler into the melt-processable polymer can be performed simultaneously, e.g., carbon black filler can be mixed into the polymer as the polymer melt is being prepared. In other aspects, obtaining the polymer melt and mixing the carbon black filler into the polymer melt can be performed sequentially, e.g., the polymer melt can first be obtained, after which the carbon black filler can be mixed into the polymer melt in one or more addition steps.

In one aspect, disclosed is a polymer composition, irrespective of how the polymer composition is made, comprising: a melt processable polymer; and a carbon black filler in an amount ranging from about 5% to about 30% by weight of the polymer composition; wherein a solid sample of the polymer composition exhibits a surface resistivity below about 10⁶ ohm/square, e.g., below about 10⁴ ohm/square. In one aspect, the carbon black filler can have the following aggregate size distribution: between about 25 weight percent and about 50 weight percent having a particle size less than 400 nm; and between about 40 weight percent and about 65 weight percent having a particle size ranging from 400 nm to 700 nm. In another aspect, the carbon black filler in powdered form has at least one or all of the following properties: a nitrogen surface area (NSA) ranging from about 45 m²/g to about 75 m²/g; a statistical thickness surface area (STSA) ranging from about 45 m²/g to about 75 m²/g; an oil absorption number ranging from about 175 cc/100 g to about 275 cc/100 g; and a compressed oil absorption number (COAN) ranging from about 85 cc/100 g to about 135 cc/100 g. In a further aspect, the carbon black filler in beaded form has at least one or all of the following properties: a nitrogen surface area (NSA) ranging from about 45 m²/g to about 75 m²/g; a statistical thickness surface area (STSA) ranging from about 40 m²/g to about 75 m²/g; an oil absorption number ranging from about 130 cc/100 g to about 220 cc/100 g; and a compressed oil absorption number (COAN) ranging from about 75 cc/100 g to about 135 cc/100 g. In this aspect of the composition, the melt-processable polymer can be a thermoplastic or thermoset polymer. In one aspect, the melt-processable polymer is a polyolefin, e.g., a polyethylene or a polypropylene. In a further aspect, the melt-processable polymer can be an acetal, acrylic, polyamide, polystyrene, polyvinyl chloride, acrylonitrile butadiene styrene, polycarbonate, or any mixture thereof.

Carbon black structure breakdown can be analyzed via transmission electron microscopy with automated image analysis (TEM/AIA) after the carbon black was extracted from the compound via pyrolysis following ASTM procedure D3849. In addition, high shear viscosities can be measured with a capillary rheometer at 230° C.

In one aspect, the inventive technology can reduce and/or prevent all or a portion of structure breakdown of a high structure carbon black.

In another aspect, the inventive technology can enable a higher conductivity at lower carbon black loading levels in polymer materials, while maintaining desirable mechanical properties and/or viscosity.

The filler of the present invention can comprise any filler having an aciniform structure. In one aspect, the filler can comprise a carbon black material. In another aspect, the filler can comprise a conductive or semi-conductive carbon black. In yet another aspect, the filler can comprise a high structure carbon black. In another aspect, the filler can comprise a carbon black having an oil absorption number (OAN), as measured by ASTM D2414, of at least about 220, 225, 230, 235, 240, 245, 250, 255, 260 cc/100 g, or higher. In other aspects, the filler can comprise a carbon black having an oil absorption number of from about 215 to about 240), from about 220 to about 240, from about 220 to about 230, from about 220 to about 250, from about 220 to about 280, from about 230 to about 270), from about 240) to about 260, from about 245 to about 265, from about 250 to about 270, or from about 250 to about 260 cc/100 g. In still other aspects, the carbon black can have an oil absorption number less than or greater than any specific value or range recited herein, and the present invention is not intended to be limited to any particular oil absorption number.

In another aspect, the filler can comprise a carbon black having a compressed oil absorption number (COAN), as measured by ASTM D3493, of from about 90 to about 130, from about 95 to about 125, from about 100 to about 120, from about 105 to about 125, from about 105 to about 115, from about 110 to about 115, from about 100 to about 125, from about 110 to about 115, or from about 110 to about 120 cc/100 g. In still other aspects, the carbon black can have a compressed oil absorption number less than or greater than any specific value or range recited herein, and the present invention is not intended to be limited to any particular compressed oil absorption number.

In various aspects, the carbon black of the present invention can have a nitrogen surface area (NSA) as measured by ASTM D6556, of from about 50 to about 70, from about 55 to about 65, from about 57 to about 65, from 55 to about 62, from about 60 to about 65, or from about 58 to about 64 m²/g. In another aspect, the carbon black has a nitrogen surface area of less than about 65, less than about 64, less than about 63, less than about 62, or less than about 61 m²/g. In still other aspects, the carbon black can have a nitrogen surface area number less than or greater than any specific value or range recited herein, and the present invention is not intended to be limited to any particular nitrogen surface area.

In various aspects, the carbon black of the present invention can have an external surface area, or statistical thickness surface area (STSA), as measured by ASTM D6556, of from about 50 to about 70, from about 55 to about 65, from about 57 to about 65, from 55 to about 62, from about 60 to about 65, or from about 58 to about 64 m²/g. In still other aspects, the carbon black can have a statistical thickness surface area less than or greater than any specific value or range recited herein, and the present invention is not intended to be limited to any particular statistical thickness surface area.

In various aspects, the carbon black of the present invention can have an iodine adsorption number, as measured by ASTM D1510, of from about 50 to about 80, from about 55 to about 70, from about 55 to about 65, from about 57 to about 65, from 55 to about 62, from about 60 to about 65, or from about 58 to about 64 m²/g. In still other aspects, the carbon black can have an iodine adsorption number less than or greater than any specific value or range recited herein, and the present invention is not intended to be limited to any particular iodine adsorption number.

In another aspect, the carbon black can have a ratio of compressed oil absorption number to oil absorption number (i.e., COAN/OAN) ratio of at least about 0.45, least about 0.47, at least about 0.49, at least about 0.51, at least about 0.53, at least about 0.55, at least about 0.57 or more.

In one aspect, the carbon black can have an NSA of from about 55 to about 65, from about 55 to about 60, from about 58 to about 62, or from about 57 to about 61 m²/g, a STSA of from about 55 to about 65, from about 55 to about 60, from about 58 to about 62, from about 55 to about 59, from about 57 to about 60, or from about 57 to about 61 m²/g, an OAN of from about 220 to about 240, from about 215 to about 230, from about 218 to about 228, from about 220 to about 230, or from about 220 to about 225 cm³/100 g, and a COAN of from about 95 to about 115, from about 100 to about 115, from about 105 to about 115, from about 100 to about 120, from about 106 to about 112, or from about 104 to about 114 cm³/100 g.

In one aspect, the carbon black can have an NSA of from about 55 to about 65, from about 55 to about 60, from about 58 to about 62, or from about 57 to about 61 m²/g, a STSA of from about 55 to about 65, from about 55 to about 60, from about 58 to about 62, or from about 57 to about 61 m²/g, and an OAN of from about 240 to about 260, from about 245 to about 260, from about 250 to about 260, from about 248 to about 258, or from about 250 to about 255 cm³/100 g.

In other aspects, the carbon black can have an ash level of less than about 0.5, less than about 0.4, less than about 0.3, less than about 0.2, less than about 0.1, less than about 0.05, less than about 0.04, less than about 0.03, or less than about 0.02 wt. %.

In one aspect, the carbon black filler used in the polymer composition, in powdered form, has at least one or all of the following properties: a nitrogen surface area (NSA) ranging from about 45 m²/g to about 75 m²/g; a statistical thickness surface area (STSA) ranging from about 45 m²/g to about 75 m²/g; an oil absorption number ranging from about 175 cc/100 g to about 275 cc/100 g; and a compressed oil absorption number (COAN) ranging from about 85 cc/100 g to about 135 cc/100 g.

In a further aspect, the carbon black filler used in the polymer composition, in beaded form, has at least one or all of the following properties: a nitrogen surface area (NSA) ranging from about 45 m²/g to about 75 m²/g; a statistical thickness surface area (STSA) ranging from about 40 m²/g to about 75 m²/g; an oil absorption number ranging from about 130 cc/100 g to about 220 cc/100 g; and a compressed oil absorption number (COAN) ranging from about 75 cc/100 g to about 135 cc/100 g.

In one aspect, the carbon black in the polymer composition can have at least one of the properties listed below in Tables A and B. In some aspect, the carbon black in the polymer composition can exhibit at least the combination of NSA and STSA values listed in Tables A and B. In further aspects, the carbon black in the polymer composition can exhibit at least the combination of NSA, STSA, and OAN values listed in the Tables A and B. In further aspects, the carbon black in the polymer composition can exhibit at least the combination of NSA, STSA, OAN, and COAN values listed in Tables A and B. In further aspects, the carbon black in the polymer composition can exhibit at least the combination of NSA, STSA, OAN, COAN, and 325 Mesh values listed in Tables A and B. In further aspects, the carbon black in the polymer composition can exhibit at least the combination of NSA, STSA, OAN, COAN, 325 Mesh, and ash content values listed in Tables A and B. In further aspects, the carbon black in the polymer composition can exhibit the combination of NSA, STSA, OAN, COAN, 325 Mesh, ash content, and sulfur content values listed in Tables A and B.

TABLE A
Carbon Black Properties in Powdered Form

| | Embodi- | Embodi- | Embodi- | Embodi- |
|---|---|---|---|---|
| | ment | ment | ment | ment (iv) - |
| | (i) | (ii) | (iii) | BCD9110 |
| NSA (m²/g) | 48-72 | 54-66 | 57-63 | 60 |
| STSA (m²/g) | 46-70 | 52-64 | 55-61 | 58 |
| OAN (cc/100 g) | 179-269 | 202-246 | 213-235 | 224 |
| COAN (cc/100 g) | 87-131 | 98-120 | 104-114 | 109 |
| 325 Mesh Water | 22-32 | 24-30 | 26-28 | 27 |
| Residue (ppm) | | | | |
| Ash Content (%) | 0.03-0.05 | 0.04 | 0.04 | 0.04 |
| Sulfur Content | 0.9-1.5 | 1-1.4 | 1-1.3 | 1.23 |
| (%) | | | | |

TABLE B
Carbon Black Properties in Beaded Form

| | Embodi- | Embodi- | Embodi- | Embodi- |
|---|---|---|---|---|
| | ment | ment | ment | ment (iv) - |
| | (i) | (ii) | (iii) | C7055U |
| NSA (m²/g) | 49-73 | 55-67 | 58-64 | 61 |
| STSA (m²/g) | 44-66 | 50-61 | 52-58 | 55 |
| OAN (cc/100 g) | 135-203 | 152-186 | 161-177 | 169 |
| COAN (cc/100 g) | 81-121 | 91-111 | 96-106 | 101 |
| 325 Mesh Water | 10-16 | 12-14 | 12-14 | 13 |
| Residue (ppm) | | | | |
| Ash Content (%) | 0.02 | 0.02 | 0.02 | 0.02 |
| Sulfur Content | 0.4-0.7 | 0.5-0.6 | 0.5-0.6 | 0.54 |
| (%) | | | | |

In one specific aspect, the carbon black can comprise Birla Carbon BCD9110 or BCD911x series carbon black, available from Birla Carbon, Marietta, Georgia USA. In one specific aspect, the carbon black can comprise Birla Carbon BCD9114 carbon black, available from Birla Carbon, Marietta, Georgia USA. In a further aspect, the carbon black can comprise Birla Carbon's CONDUCTEX 7055 Ultra Carbon Black (referred to in this application as “C7055U”). In still other aspects, the filler can comprise any other carbon black suitable for use in the present methods.

In another aspect, the carbon black can have a void volume residue at least of 100 % under mean pressure of 1 MPa; of 71% under mean pressure of 5 MPa; of 59% under mean pressure of 10 MPa; of 49% under mean pressure of 20 MPa; of 39% under mean pressure of 40 MPa; of 31% under mean pressure of 80 MPa; and/or of 24% under mean pressure of 160 MPa.

In another aspect, the carbon black can have a void volume (V′/V) of about 4.6, as determined by TEM imaging.

In another aspect, the carbon black can be in powder form or in beaded form. In other aspects, the filler can comprise a surface modified carbon black, such as, for example, an oxidized carbon black.

In one aspect, the carbon black can have about 23 wt. % aggregates with sizes greater than about 700 nm, about 35 wt. % aggregates with sizes between about 400 and about 700 nm, and about 42 wt. % aggregates with sizes less than about 400 nm.

In other aspects, the aggregate size composition can be converted from an original about 6 wt. % aggregates with sizes greater than about 700 nm, about 48 wt. % aggregates with sizes between about 400 nm and about 700 nm, and about 46 wt. % aggregates with sizes less than about 400 nm, with a gentle shear input into a polypropylene polymer.

In one aspect, the carbon black filler in the polymer composition has the following aggregate size distribution: between about 25 weight percent and about 50 weight percent having a particle size less than 400 nm; and between about 40 weight percent and about 65 weight percent having a particle size ranging from 400 nm to 700 nm.

In another aspect, with a similar gentle shear input in polypropylene, the converted carbon black (i.e., after processing) can have a void volume (V′/V) of 2.8 determined by TEM imaging.

With more aggressive shear input in polypropylene, the aggregate size composition can be converted from its original state to about 1 wt. % aggregates with sizes greater than about 700 nm, about 29 wt. % aggregates with sizes between about 400 and about 700 nm, and about 70 wt. % aggregates with sizes less than about 400 nm. With an aggressive shear input in polypropylene, aggregates with sizes greater than about 700 nm can be primarily converted to aggregates with sizes less than about 400 nm. With an aggressive shear input in polypropylene, the converted carbon black can have a V′/V of about 2.2, as determined by TEM imaging.

In one aspect, a gentle-sheared carbon black, that is, a carbon black processed under gentle conditions as described herein, can have a volume resistivity of about 9.1×10² ohm·cm at 15 wt. % carbon black loading, and about 32 ohm·cm at 20 wt. % loading in polypropylene.

In another aspect, an aggressive-sheared carbon black can have a volume resistivity of about 8.0×10¹² ohm·cm at 15 wt. % carbon black loading, and about 1.7×10⁷ ohm·cm at 20 wt. % loading in polypropylene. In another aspect, the gentle-sheared carbon black can have a percolation concentration of about 13 wt. % in polypropylene. In yet another aspect, the aggressive-sheared carbon black can have a percolation concentration of about 21 wt. % in polypropylene.

The amount of carbon black utilized in a particular polymer system can vary depending on the polymer and the desired properties of the finished article. In various aspects, the carbon black loading can be about 5 wt. %, 7 wt. %, 9 wt. %, 11 wt. %, 13 wt. %, 15 wt. %, 17 wt. %, 19 wt. %, 21 wt. %, 23 wt. %, 25 wt. %, 27 wt. %, 29 wt. %, 30 wt. %, 31 wt. %, 33 wt. %, 35 wt. %, 40 wt. %, 45 wt. %, 50 wt. %, 55 wt. %, 60 wt. %, or more. In other aspects, the carbon black loading can be from about 15 wt. % to about 60 wt. %, from about 15 wt. % to about 50 wt. %, from about 15 wt. % to about 40 wt. %, from about 15 wt. % to about 30 wt. %, from about 15 wt. % to about 30 wt. %, from about 18 wt. % to about 30 wt. %, from about 20 wt. % to about 27 wt. %, from about 22 wt. % to about 30 wt. %, or from about 25 wt. % to about 35 wt. %. In still other aspects, the specific loading of a carbon black or other filler can vary depending on the particular polymer, carbon black, and desired properties of a finished article. In such aspects, the filler loading can be less than or greater than any particular value recited herein. In any instance wherein carbon black is referred to herein, this application should be deemed to also include references to such concentrations or loadings with any other suitable filler or combinations of fillers.

The polymer can comprise any polymer or mixture of polymers suitable for use in the present invention. In one aspect, the polymer or mixture of polymers can be melt-processable. In one aspect, the polymer can comprise a thermoplastic polymer. In another aspect, the polymer can comprise a thermoset polymer. In various aspects, the polymer can comprise an olefin, such as, for example polyethylene or polypropylene. In other aspects, the polymer can comprise an acetal, acrylic, polyamide, polystyrene, polyvinyl chloride, acrylonitrile butadiene styrene, polycarbonate, or other polymer or mixture thereof.

In various specific aspects, the polymer can comprise a polypropylene, such as, for example, Ravago Certene PBM-20NB, having a melt flow index of 20, or Ravago PBM-80N, having a melt flow index of 80.

In other aspects, the composition can comprise other components, such as, for example, antioxidants, processing aids, oils, waxes, mold release agents, and/or other materials commonly used in the processing of polymeric materials.

In various aspects, the polymer and carbon black can be contacted or mixed using any suitable means. In one aspect, the carbon black and polymer can be mixed using a twin screw extruder, such as for example, a PRISM twin screw extruder. In another aspect, the carbon black and polymer can be mixed using a continuous mixer.

### EXAMPLES

Various exemplary embodiments of the invention are detailed below. These embodiments are intended to be exemplary and are not intended to limit the scope of the invention. For each of the following examples, unless indicated to the contrary, the following processes, equipment, and conditions were utilized.

### 1. Example 1

Physical and structural properties of two carbon blacks, Birla Carbon BCD9110 and BCD9114 exhibited the properties shown in Table 1. These carbon blacks were evaluated as fillers in thermoplastic polymers.

TABLE 1

| | | BCD9110 | BCD9114 | BCD9114 |
|---|---|---|---|---|
| Test Item | Unit | Sample 1 | Sample 3 | Sample 3 |
| Physical Form | / | Powder | Powder | Bead |
| NSA | m²/g | 60 | 58 | 59 |
| STSA | m²/g | 58 | 57 | 59 |
| OAN | cm³/100 g | 224 | 253 | 199 |
| COAN | cm³/100 g | 109 | — | 112 |
| 325M Residue | ppm | 27 | — | — |
| Ash | % | 0.04 | — | — |
| Sulfur | % | 1.23 | 0.14 | 0.13 |

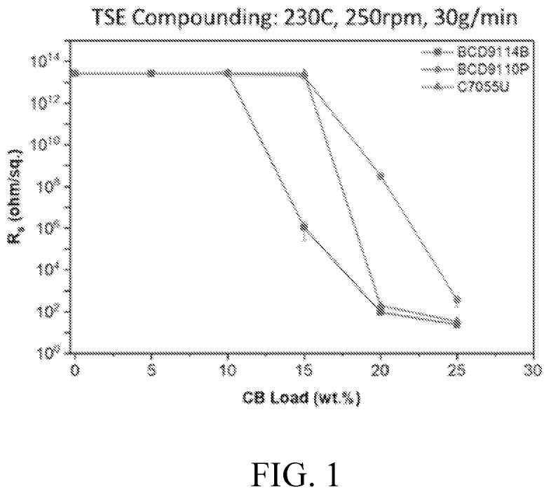

FIG. 1 shows a plot of resistivity versus carbon black loading amount for exemplary polypropylene compounds comprising Birla Carbon BCD9114B, BCD9110P, and C7055U carbon blacks, showing a lower percolation concentration for BCD9114 with a polymer compound prepared under aggressive compounding conditions (low temperature, high screw speed, high shear).

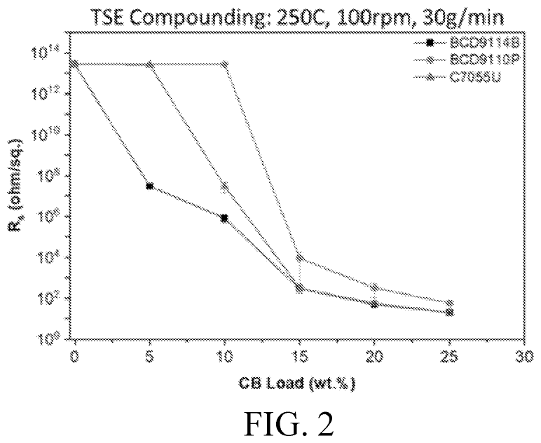

By contrast, FIG. 2 shows a plot of resistivity versus carbon black loading amount for exemplary polypropylene compounds comprising Birla Carbon BCD9114B, BCD9110P, and C7055U carbon blacks, showing a further 5% reduction in percolation concentration for BCD9114 with a polymer compound prepared under gentle compounding conditions (high temperature, low screw speed, low shear), relative to the same compound prepared under aggressive compounding conditions. These data demonstrate that conductivity of the polymer compound was improved with gentle processing conditions.

### 2. Example 2

Two high structure carbon blacks, Birla Carbon C7055U and BCD9110, were compounded in polypropylene at multiple loading levels. A twin-screw extruder was utilized for the compounding with two sets of conditions, one is aggressive (low temperature, high screw speed, high shear) and the other is gentle (high temperature, low screw speed, low shear) condition to demonstrate the effect.

Physical and structural properties of the two carbon blacks evaluations are shown in Table 2. These carbon blacks were evaluated as fillers in thermoplastic polymers. As shown, BCD9110 showed significantly higher OAN but only slightly higher COAN than C7055U in powder versus bead form.

TABLE 2

| | | BCD9110 | C7055U |
|---|---|---|---|
| Test Item | Unit | Sample 1 | Sample 4 |
| Physical Form | / | Powder | Bead |
| NSA | m²/g | 60 | 61 |
| STSA | m²/g | 58 | 55 |
| OAN | cm³/100 g | 224 | 169 |
| COAN | cm³/100 g | 109 | 101 |
| 325M Residue | ppm | 27 | 13 |
| Ash | % | 0.04 | 0.02 |
| Sulfur | % | 1.23 | 0.54 |

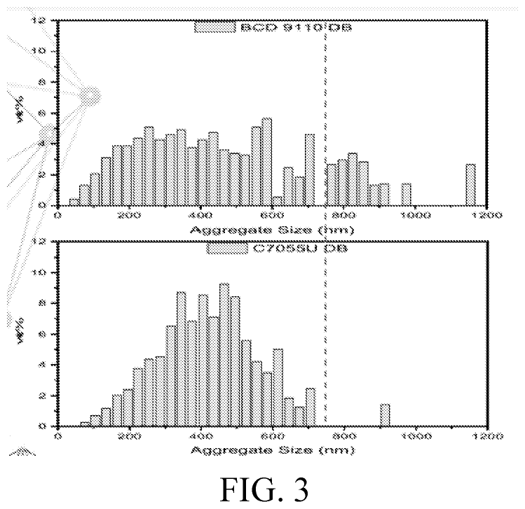

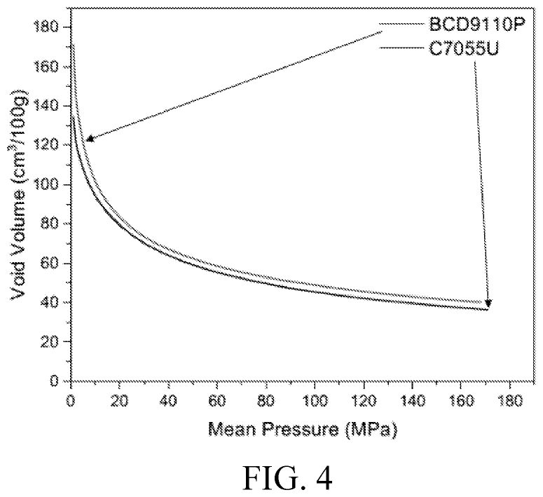

Aggregate sizes of the two carbon blacks are shown below in Table 3. Corresponding plots of aggregate size distribution are shown in FIG. 3. Plots of void volumes are shown in FIG. 4

TABLE 3

| | Aggregate Size (Wt. %) | | |
|---|---|---|---|
| Process condition | <400 nm | 400-700 nm | >700 nm |
| BCD9110 | 42 | 35 | 23 |
| C7055U | 41 | 55 | 4 |

Aggressive and gentle compounding conditions were evaluated with BCD9110 and C7055U samples according to the parameters shown in Table 4. Samples were compounded using a PRISM TSE: D=16 mm; L/D=25.

TABLE 4

| | Aggressive Process | Gentle Process |
|---|---|---|
| Extrusion Temp. (° C.) | 230 | 250 |
| Screw Speed (RPM) | 250 | 100 |
| Feed Rate (g/min) | 30 | 30 |

| | |
|---|---|
| Resin | PP (MI = 11; 230° C., 2.16 kg) |
| CB Load (Wt. %) | 5-25 |

In such aspects, both polypropylene composites exhibited significantly improved conductivity performance with a reduction of ˜10 wt. % on percolation concentration when processed on the gentle processing conditions over aggressive one. The improvement of the conductivity performance is based on higher structure retention of carbon black with gentle processing condition as demonstrated by TEM imaging.

Accordingly, the methods of the present disclosure can optimize the conductivity performance of polymer/carbon black composites via altered processing conditions. Polymer composites can achieve higher conductivity at lower carbon black loading while maintaining appropriate mechanical property and viscosity.

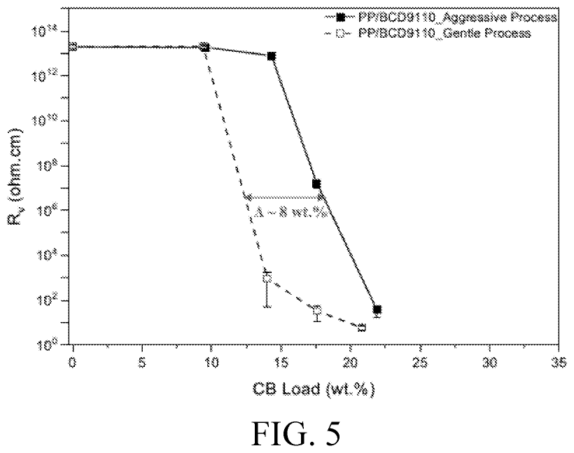

As shown in FIG. 5 and Table 5, the polypropylene/BCD9110 tape prepared according to gentle processing conditions showed a reduced percolation concentration of about 8 weight % relative to the same compound prepared according to aggressive compounding conditions.

TABLE 5

| | Volume Resistivity | | |
|---|---|---|---|
| Process condition | 10 wt. % | 15 wt. % | 20 wt. % |
| Aggressive | 1.9 E13 | 8.0 E12 | 1.7 E7 |
| Gentle | 2.0 E13 | 9.1 E2 | 3.2 E1 |

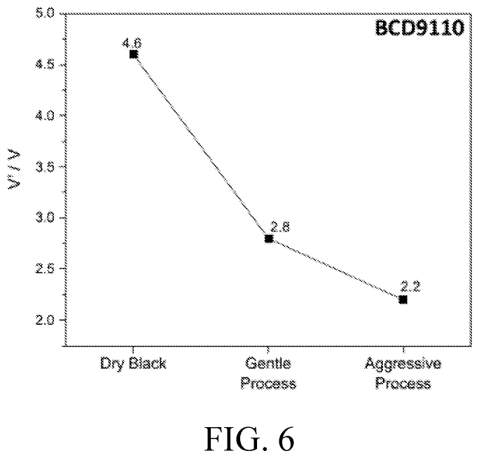

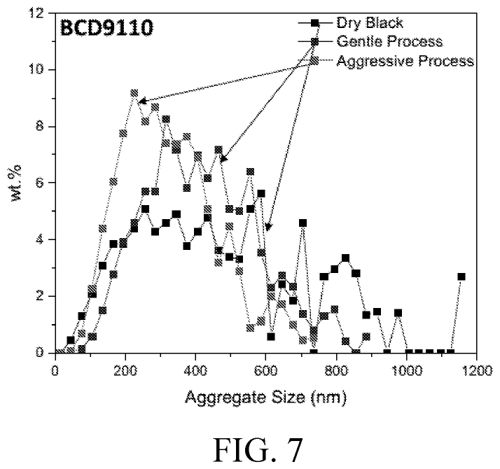

Structure retention and survival of aggregate sizes were examined, and the results showed that higher structure retention and bigger survival aggregate size of carbon black compounded with gentle process conditions correlated to the improved conductivity performance relative to compounds prepared under aggressive compounding conditions. Results are shown in Table 6 and FIGS. 6-7.

TABLE 6

| | Aggregate Size (Wt. %) | | |
|---|---|---|---|
| Process condition | <400 nm | 400-700 nm | >700 nm |
| Dry Black | 42 | 35 | 23 |
| Gentle | 46 | 48 | 6 |
| Aggressive | 70 | 29 | 1 |

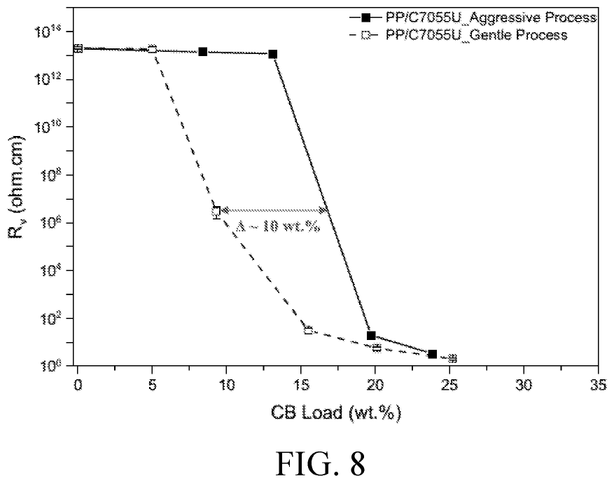

With reference to FIG. 8 and Table 7, a PP/C7055U compound prepared by a gentle compounding process reduces the percolation concentration by about 10 wt. % relative to the same compound prepared under aggressive processing conditions.

TABLE 7

| | Volume Resistivity (ohm · cm) | | |
|---|---|---|---|
| Process condition | 10 wt. % | 15 wt. % | 20 wt. % |
| Aggressive | 1.4 E13 | 1.2 E13 | 2.0 E1 |
| Gentle | 3.0 E6 | 3.1 E1 | 5.7 E0 |

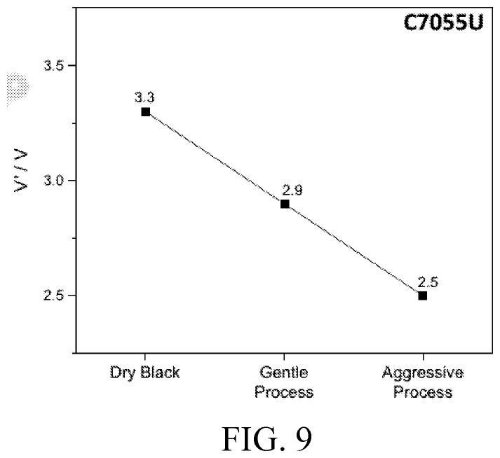

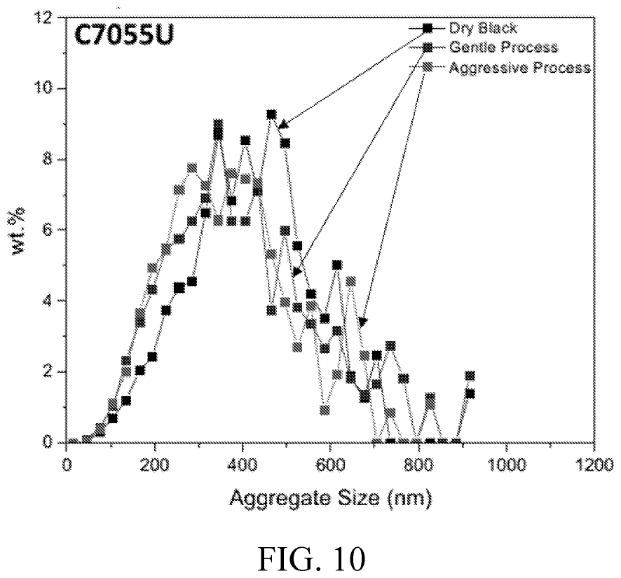

With reference to FIGS. 9-10 and Table 8, the polypropylene/C7055U compound showed higher structure retention and bigger survival aggregate size of carbon black when prepared under gentle processing conditions, which was correlated to improved conductive performance relative to compounds prepared under aggressive conditions.

TABLE 8

| | Aggregate Size (Wt. %) | | |
|---|---|---|---|
| Process condition | <4300 nm | 300-700 nm | >700 nm |
| Dry Black | 19 | 77 | 4 |
| Gentle | 29 | 62 | 9 |
| Aggressive | 32 | 63 | 5 |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A polymer composition comprising:
a) a carbon black filler; and
b) a melt-processable polymer;
wherein a tape sample prepared by extrusion of the polymer composition at an extrusion temperature (° C.) and at a screw speed (RPM), using a single- or twin-screw extruder having a screw diameter of about 16 mm and a length to diameter ratio of about 25:1, exhibits a percolation threshold of at least 5 weight percent less than a reference tape sample extruded from a substantially identical reference composition in the same single- or twin-screw extruder at the same feed rate (g/min) but (i) at a reference extrusion temperature (° C.) that is at least 5% lower than the extrusion temperature at which the tape sample is extruded and (ii) at a reference screw speed (RPM) that is at least 50% higher than the screw speed at which the tape sample is extruded;
wherein the percolation threshold is the weight percent of carbon black filler in the melt-processable polymer at which the tape sample and reference tape sample exhibit a surface resistivity below about 10⁶ ohm/square.

2. The polymer composition of claim 1, wherein the tape sample exhibits a percolation threshold of between 5 weight percent and 15 weight percent less than the reference tape sample.

3. The polymer composition of claim 1, wherein the reference extrusion temperature is between 5% and 15% lower than the extrusion temperature at which the tape sample is extruded.

4. The polymer composition of claim 1, wherein the reference screw speed is between 50% and 200% higher than the screw speed at which the tape sample is extruded.

5. The polymer composition of claim 1, wherein the carbon black filler in the polymer composition has the following aggregate size distribution:
a) between about 25 weight percent and about 50 weight percent having a particle size less than 400 nm; and
b) between about 40 weight percent and about 65 weight percent having a particle size ranging from 400 nm to 700 nm.

6. The polymer composition of claim 1, wherein the percolation threshold is the weight percent of carbon black filler in the melt-processable polymer at which the tape sample and reference tape sample exhibit a surface resistivity below about 10⁴ ohm/square.

7. The polymer composition of claim 1, wherein the carbon black filler in powdered form has at least one of the following properties:
a) a nitrogen surface area (NSA) ranging from about 45 m²/g to about 75 m²/g;
b) a statistical thickness surface area (STSA) ranging from about 45 m²/g to about 75 m²/g;
c) an oil absorption number ranging from about 175 cc/100 g to about 275 cc/100 g; and
d) a compressed oil absorption number (COAN) ranging from about 85 cc/100 g to about 135 cc/100 g.

8. The polymer composition of claim 1, wherein the carbon black filler in beaded form has at least one of the following properties:
a) a nitrogen surface area (NSA) ranging from about 45 m²/g to about 75 m²/g;
b) a statistical thickness surface area (STSA) ranging from about 40 m²/g to about 75 m²/g;
c) an oil absorption number ranging from about 130 cc/100 g to about 220 cc/100 g; and
d) a compressed oil absorption number (COAN) ranging from about 75 cc/100 g to about 135 cc/100 g.

9. The polymer composition of claim 1, wherein the melt-processable polymer is a thermoplastic or thermoset polymer.

10. The polymer composition of claim 1, wherein the melt-processable polymer is a polyolefin.

11. The polymer composition of claim 10, wherein the polyolefin is polyethylene or polypropylene.

12. The polymer composition of claim 1, wherein the melt-processable polymer is an acetal, acrylic, polyamide, polystyrene, polyvinyl chloride, acrylonitrile butadiene styrene, or polycarbonate.

13. The polymer composition of claim 1, comprising up to 40% of the carbon black filler by weight of the polymer composition.

14. A process for preparing a polymer composition, the process comprising:
a) obtaining a polymer melt from a melt-processable polymer in a mixing device;
b) mixing a carbon black filler into the polymer melt with the mixing device at a temperature (° C.) and a shear rate (s⁻¹) to provide the polymer composition;
wherein a solid sample obtained from the polymer composition exhibits a percolation threshold of at least 5 weight percent less than a solid reference sample obtained from a substantially identical reference composition mixed in the mixing device (i) at a reference temperature (° C.) that is at least 5% lower than the temperature at which the polymer composition is mixed and (ii) at a reference shear rate (s⁻¹) that is at least 50% higher than the shear rate at which the polymer composition is mixed;
wherein the percolation threshold is the weight percent of carbon black filler in the polymer composition at which the solid sample and solid reference sample exhibit a surface resistivity below about 10⁶ ohm/square.

15. The process of claim 14, wherein the solid sample exhibits a percolation threshold of between 5 weight percent and 15 weight percent less than the solid reference sample.

16. The process claim 14, wherein the reference temperature is between 5% and 15% lower than the temperature at which the solid sample is obtained.

17. The process of claim 14, wherein the reference shear rate is between 50% and 200% higher than the shear rate at which the solid sample is obtained.

18. The process of claim 14, wherein the carbon black filler in the polymer composition has the following aggregate size distribution:
a) between about 25 weight percent and about 50 weight percent having a particle size less than 400 nm; and
b) between about 40 weight percent and about 65 weight percent having a particle size ranging from 400 nm to 700 nm.

19. The process of claim 14, wherein the percolation threshold is the weight percent of carbon black filler in the polymer composition at which the solid sample and solid reference sample exhibit a surface resistivity below about 10⁴ ohm/square.

20. The process of claim 14, wherein the carbon black filler in powdered form has at least one of the following properties:
a) a nitrogen surface area (NSA) ranging from about 45 m²/g to about 75 m²/g;
b) a statistical thickness surface area (STSA) ranging from about 45 m²/g to about 75 m²/g;
c) an oil absorption number ranging from about 175 cc/100 g to about 275 cc/100 g; and d) a compressed oil absorption number (COAN) ranging from about 85 cc/100 g to about 135 cc/100 g.

21-36. (canceled)
